(19) United States
(12) Patent Application Publication
(10) Pub. No.: US 2010/0111070 A1
(43) Pub. Date: May 6, 2010

(54) Apparatus, Method, And Tangible Machine-Readable Medium Thereof For Time Synchronization Procedure In A Cellular Network

(75) Inventor: Hsien-Tsung HSU, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Broadband wireless Technology Corp., Hsi-Chih City (TW)

(21) Appl. No.: 12/608,739

(22) Filed: Oct. 29, 2009

Related U.S. Application Data
(60) Provisional application No. 61/110,558, filed on Nov. 1, 2008.

(51) Int. Cl. H04J 3/06

(52) U.S. Cl. 370/350

(57) ABSTRACT

The apparatus, signaling method, and tangible machine-readable medium thereof for time synchronization procedure in a cellular network are provided, wherein the network comprising a plurality of femto base stations and relay stations. The source of providing time synchronization information to femto base stations and relay station could be macro base station, femto base station, relay station or mobile station. The apparatus comprises a clock module, a receiving module, a transmission module, and a determination module. The clock module is configured to generate clocks to synchronize with the network. According to the source of providing time synchronization information to femto base stations and relay stations, the receiving module is configured to receive the system synchronization and access information, or the ranging messages including the ranging request and ranging response messages, the transmission module is configured to transmit the system synchronization and access information, or the ranging messages including the ranging request and ranging response messages. The determination module is configured to determine the timing with respect to the system clock.

This application claims the benefit of U.S. Provisional Application Ser. No. 61/110,558 filed on Nov. 1, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to an apparatus, a signaling method, and a tangible machine-readable medium for time synchronization in a network composed of outdoor base station (13S), outdoor relay station (RS), indoor RS, and indoor base station (femto BS); more specifically, relates to an apparatus, a signaling method, and a tangible machine-readable medium for time synchronization procedure in femto BS and relays under the IEEE 802.16m and LTE/LTE-A standards.

2. Descriptions of the Related Art

Although the IEEE 802.16 and LTE/LTE-A standards already provide greater bandwidths, lower building cost, better service quality and expansibility, there still are some defects of coverage and signal quality of the IEEE 802.16 and LTE/LTE-A standards. Therefore, the IEEE 802.16/LTE/LTE-A standard working groups have included the indoor femto base station (femto BSs) and relay station (RS). The major difference between indoor femto BS and outdoor BS is the media type of backhaul link. Femto BS uses the wired link, such as ADSL and Cable link, as the backhaul link.

Please refer to FIG. 1, which illustrates the cellular network topology, which comprises an outdoor BS, an indoor or outdoor RS, an indoor femto BS, a mobile station (MS), a backbone network and a network time protocol server (NTP), wherein the MS is one type of subscriber station (SS) which has mobility. The MS intends to access the backbone network via the outdoor BS, indoor femto BS and relay. The MS synchronizes with the BS by executing the ranging procedure during network entry. If there are multiple BSs and RSs in a wireless network, the time synchronization procedure among BSs and relays, which is used to ensure that the signals transmitted from several BSs/RSs arrive at the MSs at almost the same time so as to minimize the interference, is basically achieved by either the satellite-based technologies such as GPS or the internet timing protocols over wired backhaul, such as network time protocol (NTP) and IEEE 1588. However, these two time synchronization procedures are inapplicable for femto BSs and relay in some environments. More specifically, the satellite-based technology may be inapplicable for the femto BSs, whereas the internet timing protocols may be inapplicable for relays.

The considered scenario, as shown in FIG. 1, is that the type of backhaul link of femto BS is wired link and the femto BS can communicate with the other BSs and network servers such as NTP servers via backhaul network. It can be understood that, a femto BS or RS will not provide service to MS unless the time synchronization with cellular network is fully accomplished. Please refer to FIG. 2, which comprises a MacroBS, FemtoBS A, FemtoBS B and an MS. The further considered scenario is that FemtoBS A can synchronize with the network via MacroBS directly and MS can synchronize with the network via FemtoBS A after FemtoBS A has already synchronized with the network, while FemtoBS B cannot synchronize with the network via Macro BS directly. Instead, FemtoBS B can synchronize with the network via the synchronized FemtoBS A, or the synchronized MS, or combination of them.

In order to resolve the problems mentioned above, an efficient solution of time synchronization for the femto BSs and RSs is required. Since the code-division-multiple-access (CDMA) codes have the feature of orthogonality, the collision caused by two or more CDMA signals is significantly reduced. Therefore, a CDMA-based time synchronization procedure over the wireless link is invented, which allows a number of femto BSs or RSs to fulfill the time synchronization requirement simultaneously on a shared radio resource.

### SUMMARY OF THE INVENTION

The primary objective of this invention is to provide three methods for time synchronization for wireless networks under IEEE 802.16j, IEEE 802.16m, LTE and LTE-Advanced and the following standards. These methods synchronize the femto BSs and RSs to the network by referring the timing information of the neighboring BS(s) (macro BS or femto BS) and/or MS(s) who have already synchronized with the network. In order to ensure that time synchronization methods can be used universally for the femto BSs and RSs, the three methods are performed over the wireless link based on the CDMA codes which parameter set is periodically broadcasted by the networks, such as the length of CDMA code, the number of available CDMA codes, the resource unit for the CDMA-based time synchronization, and so on.

The first method comprises the steps of: synchronized macro BS broadcasts the preamble and the parameter set of CDMA codes; unsynchronized femto BS (RS) receiving the preamble and the parameter set of CDMA codes; unsynchronized femto BS (RS) using the CDMA codes to range with the synchronized macro BS; and the synchronized macro BS adjusting the timing of unsynchronized femto BS (RS) so that the femto BS (RS) can achieve synchronization with the network.

The second method comprises the steps of: unsynchronized femto BS (RS) requests the network to assist the time synchronization procedure via backhaul link; network determining the location of unsynchronized femto BS (RS) via backhaul link; network commanding the neighboring synchronized MSs of unsynchronized femto BS (RS) to assist time synchronization; unsynchronized femto BS (RS) broadcasts the preamble and the parameter set of CDMA codes; synchronized MS receiving the preamble and the parameter set of CDMA codes; synchronized MS using these CDMA codes to range with the unsynchronized femto BS (RS); MS estimating the time difference between the propagation delay toward the unsynchronized femto BS (RS) and the propagation delay toward its serving BS; and MS adjusting the timing of unsynchronized femto BS (RS) according to the estimated time difference so that the femto BS (RS) can achieve synchronization with the network.

The third method comprises the steps of: synchronized femto BS (RS) broadcasts the preamble and the parameter set of CDMA codes; unsynchronized femto 13S (RS) receiving the preamble and the parameter set of CDMA codes; unsynchronized femto BS (RS) using the CDMA codes to range with the synchronized femto BS (RS); and synchronized femto BS (RS) adjusting the timing of unsynchronized femto BS (RS) so that the unsynchronized femto BS (RS) can achieve synchronization with the network.

These methods of synchronizing femto BS (RS) to network via synchronized macro BS, synchronized femto BS or synchronized MS are initiated by unsynchronized femto BS (RS).

Another object of this invention is to provide an apparatus for an unsynchronized femto 13S or RS to execute ranging procedure with synchronized BS or RS. The apparatus comprises a receiving module, a transmission module, a determination module, and a clock module. The receiving module is configured to receive the preamble, parameter set of CDMA codes and the ranging response message from synchronized BS or RS. The transmission module is configured to transmit the CDMA ranging code to synchronized BS or RS. The determination module is configured to determine the timing according to the timing adjustment information carried in the ranging response message. The clock module is configured to generate the clocks for the unsynchronized BS and RS to synchronize with network.

Yet a further objective of this invention is to provide an apparatus for a synchronized MS to execute ranging procedure with an unsynchronized femto BS or RS. The apparatus comprises a receiving module, a transmission module, a determination module, and a clock module. The receiving module is configured to receive the preamble, parameter set of CDMA and ranging response message from unsynchronized femto BS or RS. The transmission module is configured to transmit the CDMA ranging code to unsynchronized femto BS or RS. The determination module is configured to determine the timing difference between its local clock, which is synchronized with network, and the timing adjustment value carried in the ranging response message. The clock module is configured to generate the clocks for the unsynchronized BS and RS to synchronize with network.

Yet a further objective of this invention is to provide an apparatus for an unsynchronized femto BS or RS to handle the ranging procedure with synchronized MS. The apparatus comprises a transmission module, a receiving module, a determination module, and a clock module. The transmission module is configured to transmit the preamble, parameter set of CDMA codes and the ranging response message to synchronized MS. The receiving module is configured to receive the CDMA ranging code and the timing adjustment message sent from synchronized MS. The determination module is configured to determine the timing according to the timing adjustment information carried in the timing adjustment message. The clock module is configured to generate the clocks for the unsynchronized BS and RS to synchronize with network.

Yet a further objective of this invention is to provide a tangible machine-readable medium storing a computer program for femto BS or RS to enable an apparatus to execute a signaling method for performing the ranging procedure at femto BS or RS. The signaling method comprising the steps of: enabling the apparatus to receive the preamble and parameter set of CDMA codes from the synchronized BS or RS; enabling the apparatus to transmit the CDMA code to the synchronized BS or RS; and enabling the apparatus to receive the ranging response message from the synchronized BS or RS, the message indicating the timing adjustment information with respect to the synchronized BS or RS.

Yet a further objective of this invention is to provide a tangible machine-readable medium storing a computer program for MS to enable an apparatus to execute ranging procedure with an unsynchronized femto BS or RS. The signaling method comprising the steps of: enabling the apparatus to receive the preamble and parameter set of CDMA codes from the unsynchronized femto BS or RS; enabling the apparatus to transmit the CDMA code to the unsynchronized femto BS or RS; enabling the apparatus to receive the ranging response message from the unsynchronized femto BS or RS, the message indicating the timing adjustment information with respect to the unsynchronized femto BS or RS; enabling the apparatus to estimate the time difference between the propagation delay toward the unsynchronized femto BS or RS and the propagation delay toward its serving BS; and enabling the apparatus to transmit the timing adjustment information to unsynchronized femto BS according to the estimated result.

Yet a further objective of this invention is to provide a tangible machine-readable medium storing a computer program for femto BS or RS to enable an apparatus to execute a signaling method for handling the ranging procedure at femto BS. The signaling method comprising the steps of: enabling the apparatus to transmit the preamble and parameter set of CDMA codes to the synchronized MS; enabling the apparatus to receive the CDMA code from the synchronized MS; enabling the apparatus to transmit the ranging response message to the synchronized MS; enabling the apparatus to receive the timing adjustment message from the synchronized MS; and enabling the apparatus to adjust the timing in response to the timing adjustment message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a cellular network topology, which comprises an outdoor BS, an indoor or outdoor RS, an indoor femto BS, an mobile station (MS), a backbone network and a network time protocol server (NTP);

FIG. 2 illustrates a cellular network topology, which comprises a MacroBS, FemtoBS A, FemtoBS B and an MS;

FIG. 3 is a schematic diagram of the first embodiment of the present invention;

FIG. 4 is a schematic diagram of the second embodiment of the present invention;

FIG. 5 is a schematic diagram of the third embodiment of the present invention;

FIG. 6 illustrates that timing relationship between signals transmitted from MacroBS, FemtoBS A, FemtoBS B to arrive at MS when MicoBS, FemtoBS A and FemtoBS B have already synchronized;

FIG. 7 is a schematic diagram of a concrete example of the first embodiment of the present invention, wherein the FemtoBS A performs the CDMA-based time synchronization procedure with MacroBS directly;

FIG. 8 is a schematic diagram of a concrete example of the first embodiment of the present invention, wherein the FemtoBS B performs the CDMA-based time synchronization procedure with MacroBS via FemtoBS A who has already synchronized with MacroBS; and

FIG. 9 is a schematic diagram of a concrete example of the second and third embodiments of the present invention, wherein the FemtoBS B performs the CDMA-based time synchronization procedure with MacroBS via MS who has already synchronized with MacroBS or FemtoBS A.

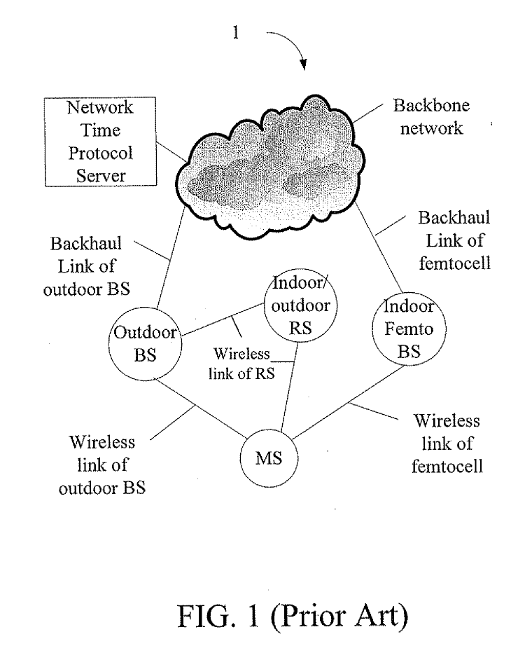

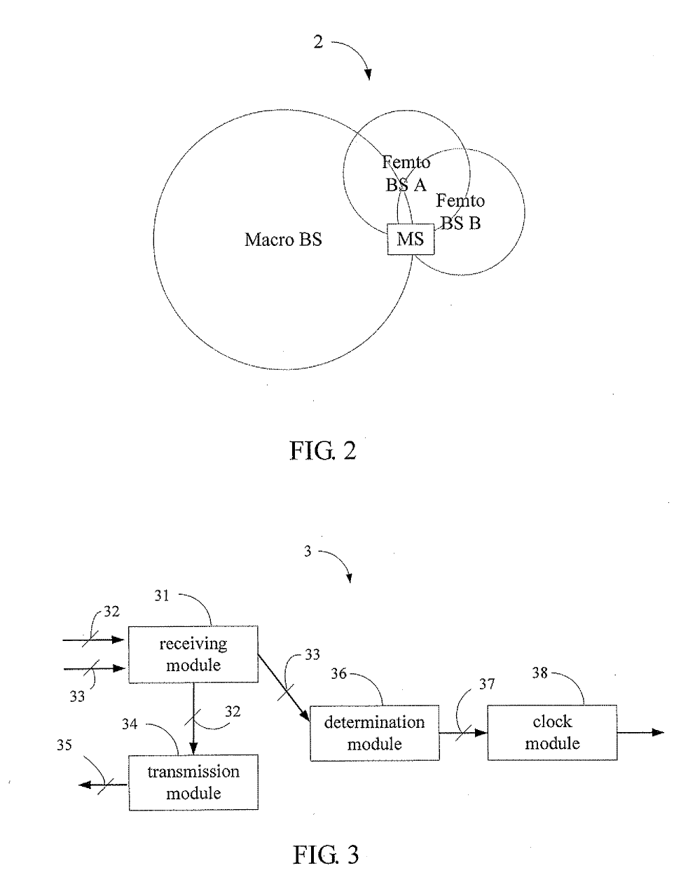

### DESCRIPTION OF THE PREFERRED EMBODIMENT

The present invention provides an apparatus, a signaling method, and a tangible machine-readable medium thereof for time synchronization procedure in a cellular network. In the following embodiments, femto-networks based on the IEEE 802.16e standard are used. However, the scope of the present invention is not limited to the applications based on the IEEE 802.16e standard. The time synchronization operations in a network based on the IEEE 802.16e standard, GPS, NTP protocol, and IEEE 1588 are well-known by people skilled in the art, and are not repeated again. A cellular network has two kinds of time synchronization operations: wired-based and wireless-based time synchronization operations. In this invention, the wireless-based time synchronization operation in the cellular network is described. It means that the time synchronization operation relating to an unsynchronized BS and RS ranging with the synchronized BS, RS or MS is described.

A first embodiment of the present invention is shown in FIG. 3, which shows an apparatus 3 for receiving preamble and parameter set of CDMA ranging codes 32 from the synchronized BS or RS, and transmitting CDMA code 35 to the synchronized BS or RS. The apparatus 3 serves as a femto BS or RS which is not synchronized with the cellular network yet. The apparatus 3 comprises a receiving module 31, a transmission module 34, a determination module 36, and a clock module 38. The receiving module 31 is configured to receive the preamble, and the parameter set of CDMA codes 32 and the ranging response message 33 sent from the synchronized BS or RS. The parameter set of CDMA codes 32 is also sent to the transmission module 34 so that the transmission module can transmit an appropriate CDMA code 35 to correspondent BS or RS. In addition, the ranging response message 33 is also sent to the determination module 36 so that the determination module 36 can obtain the propagation delay between apparatus 3 and the synchronized BS or RS. The determination module 36 is configured to determine the propagation delay between apparatus 3 and the synchronized BS or RS. If the determination module 36 obtains the required propagation delay, it generates a timing signal 37 to the clock module 38. The clock module 38 is configured to generate the timing for the apparatus 3 to synchronize with cellular network.

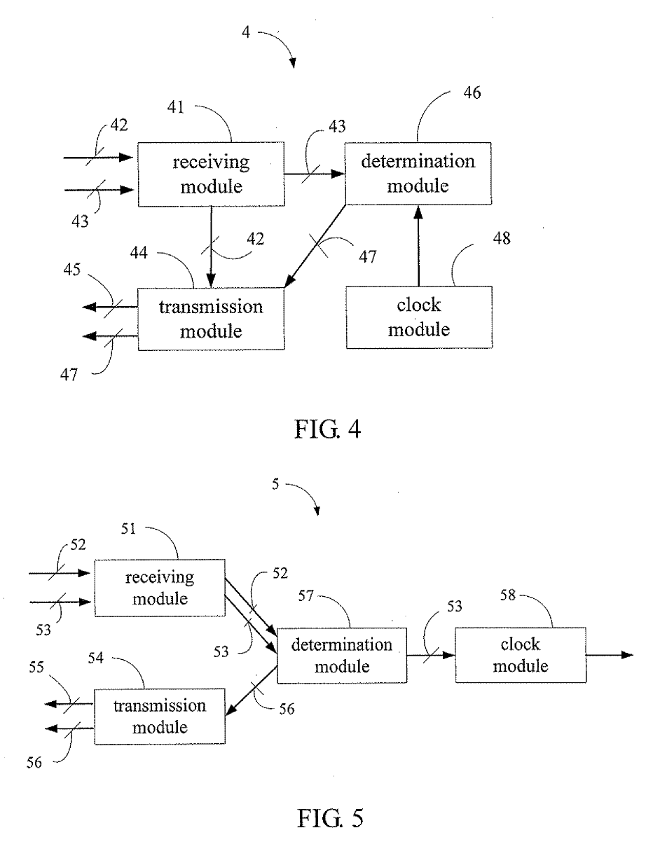

A second embodiment of the present invention is shown in FIG. 4, which shows an apparatus 4 for receiving preamble and parameter set of CDMA ranging codes 42 from the unsynchronized femto BS or RS, and transmitting a CDMA code 45 to the unsynchronized femto BS or RS. The apparatus 4 serves as an MS which is already synchronized with the cellular network. The apparatus 4 comprises a receiving module 41, a transmission module 44, a determination module 46, and a clock module 48. The receiving module 41 is configured to receive the preamble, the parameter set of CDMA codes 42 and the ranging response message 43 sent from the unsynchronized femto BS or RS. The parameter set of CDMA codes 42 is also sent to the transmission module 44 so that the transmission module 44 can transmit an appropriate CDMA code 45 to correspondent femto BS or RS. In addition, the ranging response message 43 is also sent to the determination module 46 so that the determination module 46 can obtain the propagation delay between apparatus 4 and the unsynchronized femto BS or RS. The determination module 46 is configured to determine the time difference between the propagation delay toward the unsynchronized BS or RS and the propagation delay toward its serving BS or RS by referring to the clock signals generated from clock module 48. If the determination module 46 obtains the time difference, it generates a timing adjustment message 47 to the transmission module 44. The transmission module 44 then transmits the timing adjustment message 47 to the unsynchronized BS or RS to complete the time synchronization procedure. The clock module 48 is configured to generate the clocks for the apparatus 4 to synchronize with cellular network.

A third embodiment of the present invention is shown in FIG. 5, which shows an apparatus 5 for transmitting preamble and the parameter set of CDMA ranging codes 52 to the synchronized MS, and receiving a CDMA code 52 from the synchronized MS. The apparatus 5 serves as a BS or RS which is not synchronized with the cellular network yet. The apparatus 5 comprises a receiving module 51, a transmission module 54, a determination module 57, and a clock module 58. The transmission module 54 is configured to transmit preamble, the parameter set of CDMA codes 55 and the ranging response message 56 to the synchronized MS. The receiving module 51 is configured to receive the CDMA code 52 and the timing adjustment message 53 sent from the MS which has synchronized with cellular network. The received CDMA code 52 is also sent to the determination module 57 so that the determination module 57 can determine the propagation delay toward synchronized MS. In addition, the received timing adjustment message 53 is also sent to the determination module 57 so that the determination module 57 can determine the timing with respect to the cellular network. The determination module 57 is configured to determine the propagation delay toward the synchronized MS according to the received CDMA code, and determine the timing with respect to network according to the received timing adjustment message 53. If the determination module 57 receives the CDMA ranging code, it estimates the propagation delay toward the synchronized MS and sends the ranging response message 56 to the transmission module 54. On the other hand, if the determination module 57 receives the timing adjustment message 53, it sends a timing adjustment message 53 to the clock module 58. The clock module 58 is configured to generate the clocks for the apparatus 5 to synchronize with cellular network.

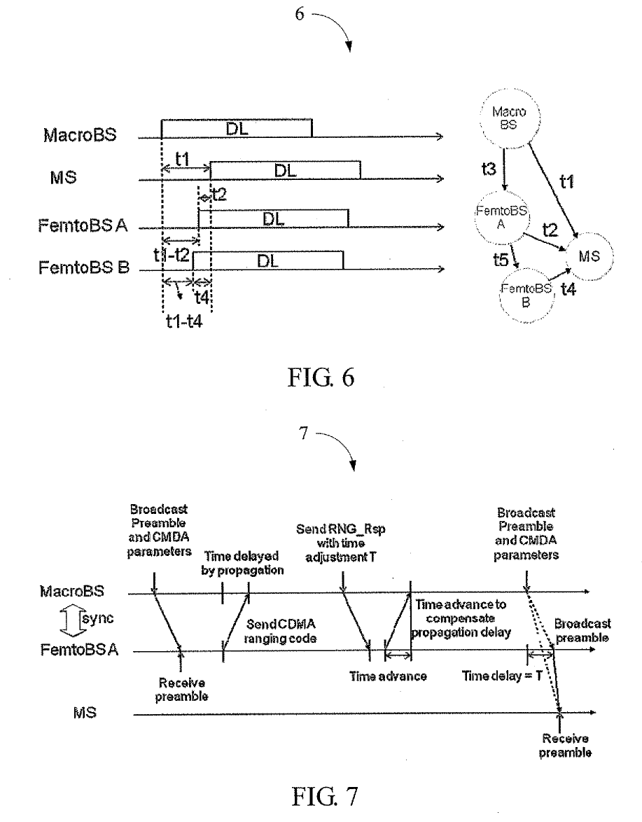

As mentioned, the apparatuses 3 and 5 are femto BS or RS, and the apparatus 4 is an MS in a cellular network. FIG. 6 illustrates that timing relationship between signals transmitted from MacroBS, FemtoBS A and FemtoBS B when all of them have already synchronized with each other. In FIG. 6, the signals from MacroBS, FemtoBS A and FemtoBS B arrive at MS at almost the same time such that the interferences between these three BSs are minimized. Specifically, let t1, t2, t3, t4 and t5 denote the propagation delays from MacroBS to MS, from FemtoBS A to MS, from MacroBS to FemtoBS A, from FemtoBS B to MS, and from FemtoBS A to FemtoBS B, respectively. The required transmit delays for FemtoBS A and FemtoBS B starting sending data to MS are (t1−t2) and (t1−t4), respectively, later than MacroBS. Due to small transmission range for a FemtoBS (typically, <100 meters), delays t2, t4 and t5 are ignorable and t1≈t3. So, FemtoBS A and FemtoBS B could set the transmit delay to t3 (later than MacroBS).

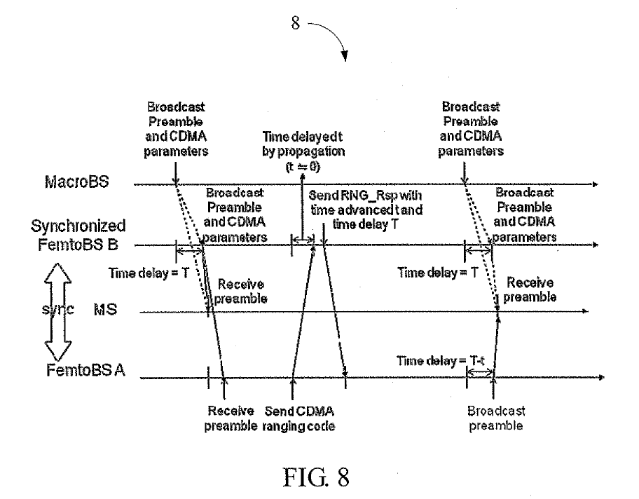

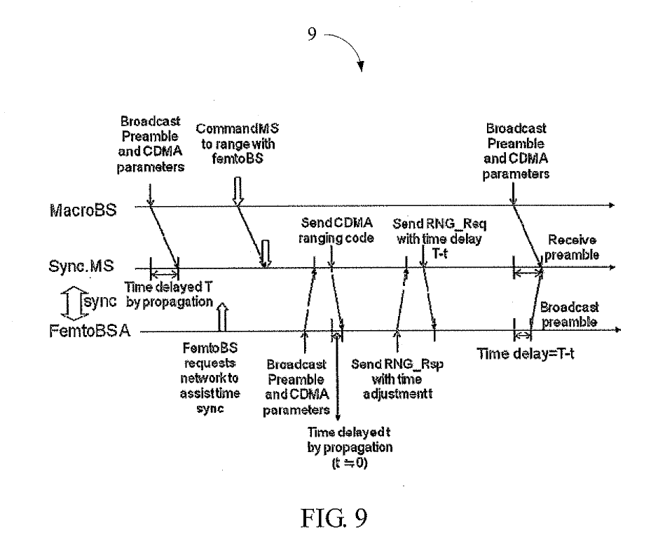

Please refer to FIG. 7, FIG. 8 and FIG. 9 for three concrete examples, which respectively show three different time synchronization methods in cellular systems 7, 8 and 9. The cellular system 7 comprises an MS, a femto BS (FemtoBS A) and a MacroBS, wherein the FemtoBS A is the apparatus 3 of this embodiment. The cellular system 8 comprises an MS, two femto BSs (FemtoBS A and FemtoBS B), and a MacroBS, wherein the FemtoBS A is the apparatus 3 of this embodiment. The cellular system 9 comprises an MS, a femto BS (FemtoBS A) and a MacroBS, wherein the MS and Femto BS A are the apparatuses 4 and 5 of this embodiment respectively. In FIG. 7, FIG. 8 and FIG. 9, the horizontal axes indicate the time scale, ‘RNG_Req’ and ‘RNG_Rsp’ indicate the ranging request message and ranging response message respectively.

FIG. 7 illustrates that CDMA-based time synchronization procedure between FemtoBS A and MacroBS when FemtoBS A is located in the coverage of MacroBS. Specifically, FemtoBS A performs the time synchronization procedure as follows. First, FemtoBS A obtains the downlink timing reference by acquiring the preamble broadcasted by MacroBS and then obtains the relative uplink timing information and the parameters of CDMA codes by decoding the management messages or control signals sent by MacroBS. Accordingly, FemtoBS A can select a CDMA code (ranging code) and send to MacroBS. MacroBS then sends ranging response management messages (RNG_Rsp) to FemtoBS A to adjust its transmission timing (delay T as shown in FIG. 7) based on the timing when it received the CDMA code. The time synchronization procedure for FemtoBS A to synchronize with the network is then complete.

FIG. 8 illustrates that CDMA-based time synchronization procedure between FemtoBS A and MacroBS when FemtoBS A is located outside the coverage of MacroBS. Specifically, FemtoBS A performs the time synchronization procedure via FemtoBS B as follows when FemtoBS B has already synchronized with the network. First, FemtoBS A tries to acquire the preamble sent from FemtoBS B. Then, FemtoBS A selects a CDMA code and sends to FemtoBS B according to the relative uplink timing information and the parameters of CDMA code obtained by decoding the management messages or control signals sent from FemtoBS B. Since FemtoBS B has already synchronized with MacroBS, it can inform FemtoBS A about the time differences between FemtoBS A and itself (delay t as shown in FIG. 8) and between MacroBS and itself (delay T as shown in FIG. 8) by management messages or control signals. According to the time difference, FemtoBS A adjusts its transmission timing and the time synchronization procedure for FemtoBS A to synchronize with the network is then complete.

FIG. 9 illustrates that CDMA-based time synchronization procedure between FemtoBS A and MacroBS when FemtoBS A is located outside the coverage of MacroBS. Specifically, FemtoBS A performs the time synchronization procedure via MS as follows when MS has already synchronized with the network. First, FemtoBS A requests the network to assist the synchronization procedure via backhaul connection. Then, the network assigns MacroBS to request the synchronized MS to acquire the preamble of FemtoBS A. When MS successfully acquires the preamble of FemtoBS A, MS selects a CDMA code and sends to FemtoBS A according to the relative uplink timing information and the parameters of CDMA code obtained by decoding the management messages or control signals sent from FemtoBS A. FemtoBS A then sends management messages or control signals to MS to adjust its transmission timing (delay t as shown in FIG. 9) based on the timing when it received the CDMA code. Since MS has already synchronized with MacroBS, it can calculate the time difference between MacroBS and FemtoBS A (delay T-t as shown in FIG. 9) and informs FemtoBS A by management messages or control signals. According to the time difference, FemtoBS A adjusts the transmission timing and the time synchronization procedure for FemtoBS A to synchronize with the network is then complete.

From FIG. 7, FIG. 8 and FIG. 9, it can be seen that the time synchronization between the Femto BS and cellular network appears efficient. That is, although the Femto BS or RS is unable to synchronize with network via GPS or wired solution, it can still synchronize with network via the assistance of neighboring BS or MS, who has synchronized with network.

According to the above configurations, the present invention provides an apparatus to generate appropriate time synchronization procedure in accordance with the network topology. This can effectively synchronize femto BSs and RSs to MacroBS to minimize the interference in the cellular system.

Each of the aforementioned methods can use a tangible machine-readable medium for storing a computer program to execute the aforementioned steps. The tangible machine-readable medium can be a floppy disk, a hard disk, an optical disc, a flash disk, a tape, a database accessible from a network or a storage medium with the same functionality that can be easily thought by people skilled in the art.

According to the aforementioned descriptions, the present invention provides a new approach to synchronize between femto BS (RS) and MacroBS according to the visibility of MacroBS with respect to femto BS (RS). This will effectively develop the wireless system to provide services. The present invention can be utilized in femto-network and relay-network, such as those based on the IEEE 802.16e and 802.16j standards.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for executing time synchronization procedure to synchronize a femto base station or a relay station with a synchronized femto base station or relay station in a cellular network, comprising:
a receiving module being configured to receive the system synchronization, the access information and the timing adjustment information from synchronized femto base station or relay station;
a transmission module being configured to transmit ranging signal to a synchronized femto base station or relay station;
a determination module being configured to determine the timing adjustment information; and
a clock module being configured to generate the clocks to synchronize with the network.

2. The apparatus of claim 1, wherein the receiving module is further configured to receive the system synchronization information, the access information and the timing adjustment information from macro base station; and the transmission module is further configured to transmit ranging signal to macro base station.

3. An apparatus for executing time synchronization procedure at synchronized mobile station to assist the femto base station or relay station to synchronize with macro base station in a cellular network, comprising:
a receiving module being configured to receive the system synchronization information, the access information, the timing adjustment information from unsynchronized femto base station or relay station;
a transmission module being configured to transmit ranging signal and the timing adjustment information to unsynchronized femto base station or relay station;
a determination module being configured to determine the time adjustment information for the unsynchronized femto base station or relay station; and
a clock module being configured to generate the clocks to synchronize with the network.

4. An apparatus for executing time synchronization procedure at femto base station and relay station to utilize a synchronized mobile station to synchronize with macro base station in a cellular network, comprising:
a receiving module being configured to receive the ranging signal and the timing adjustment information from synchronized mobile station;
a transmission module being configured to transmit the system synchronization and the access information, the timing adjustment information to synchronized mobile station;
a determination module being configured to determine the timing adjustment information for the synchronized mobile station and the timing adjustment information for the local clock module; and
a clock module being configured to generate the clocks to synchronize with the network.

5. A signaling method for obtaining the timing adjustment information from a macro station, a synchronized femto station or a synchronized relay station in a cellular network, comprising the steps of:
receiving the system synchronization information and the access information;
transmitting the ranging signal according to the access information;
receiving the timing adjustment information; and
determining the timing adjustment information.

6. A signaling method for obtaining the timing adjustment information from a synchronized mobile station in a cellular network, comprising the steps of:
transmitting the system synchronization information and the access information;
receiving the ranging signal from the mobile station;
transmitting the timing adjustment information to the mobile station;
receiving the timing adjustment information from the mobile station; and
determining the timing adjustment information.

7. A signaling method for synchronized mobile station providing the timing adjustment information to the unsynchronized femto base station or relay station in a cellular network, comprising the steps of:
receiving the time synchronization assistance request from network;
receiving the system synchronization information and the access information;
transmitting the ranging signal to the unsynchronized femto base station or relay station;
receiving the timing adjustment information from the unsynchronized femto base station or relay station;
determining the timing adjustment information for the unsynchronized femto base station or relay station according to the timing of macro base station and the timing of the unsynchronized femto base station or relay station;
transmitting the timing adjustment information to the unsynchronized femto base station or relay station.

8. A tangible machine-readable medium storing a computer program to enable an apparatus to execute a signaling method for time synchronization procedure with a synchronized macro base station, a synchronized base station or a synchronized relay station in a cellular network, the signaling method comprising the steps of:
enabling the apparatus to determine the target station of time synchronization procedure;
enabling the apparatus to receive the system synchronization information and the access information;
enabling the apparatus to transmit ranging signal to the synchronized femto base station or relay station;
enabling the apparatus to receive the timing adjustment information from the synchronized femto base station or relay station; and
enabling the apparatus to determine the timing to synchronize with network.

9. A tangible machine-readable medium storing a computer program to enable an apparatus to execute a signaling method for time synchronization procedure with a synchronized mobile station in a cellular network, the signaling method comprising the steps of:
enabling the apparatus to determine the target station of time synchronization procedure;
enabling the apparatus to transmit the system synchronization information and the access information;
enabling the apparatus to receive ranging signal from the synchronized mobile station;
enabling the apparatus to determine the timing adjustment information for the synchronized mobile station.
enabling the apparatus to receive the timing adjustment information from the synchronized mobile station; and
enabling the apparatus to determine the timing to synchronize with network.

10. A tangible machine-readable medium storing a computer program to enable an apparatus to execute a signaling method for time synchronization procedure with a unsynchronized femto base station or relay station in a cellular network, the signaling method comprising the steps of:
enabling the apparatus to determine the target station of time synchronization procedure;
enabling the apparatus to receive the system synchronization information and the access information;
enabling the apparatus to transmit ranging signal to the unsynchronized femto base station or relay station;
enabling the apparatus to receive the timing adjustment information from the unsynchronized femto base station or relay station;
enabling the apparatus to determine the timing adjustment information to the unsynchronized femto base station or relay station; and
enabling the apparatus to transmit the timing adjustment information to the unsynchronized femto base station or relay station.
